(19) United States
(12) Patent Application Publication
(10) Pub. No.: US 2004/0030642 A1
(43) Pub. Date: Feb. 12, 2004

(54) Method and arrangement for the transfer of an electronic sum of money from a credit store

(76) Inventor: Per Vindeby, Munchen (DE)

Correspondence Address: MORRISON & FOERSTER LLP, 1650 TYSONS BOULEVARD, SUITE 300, MCLEAN, VA, 22102, US

(21) Appl. No.: 10/381,653

(22) PCT Filed: Sep. 11, 2001
(86) PCT No.: PCT/EP01/10493

(30) Foreign Application Priority Data
Sep. 29, 2000 (EP) 00121482.4

(51) Int. Cl. G06F 17/60

(52) U.S. Cl. 705/39

(57) ABSTRACT

The invention relates to a method for the transfer of an electronic sum of money from a credit store of a money sender to an account or credit store of a money receiver, by means of a telecommunication and data network, whereby the transmission of the necessary data occurs by reference to an identification code for the money receiver, or for the money transfer between a first and a second server of at least one service operator.

The invention relates to a method and an arrangement for the transfer of an electronic sum of money from a credit store to an account or to another credit store by means of a telecommunication and data network.

In addition to its use as a communication means and information source for what is now hundreds of millions of people, the Internet is becoming increasingly important as a purchasing source. In particular, a significant proportion of trade in software, books and travel takes place on the Internet, but a wide range of other products and services are also ordered and paid for via the Internet. The payment for the services in question on the Internet in the originally established and still most common way requires the separate entry of the relevant data records in each case at least with each business partner even if not for the individual transaction. This method of payment then gives the business partner an insight into sensitive personal data and even the possibility of storing it permanently.

The Internet has now become very important for the processing of other payment transactions in both commercial and private areas. Virtually all banks in industrial countries offer as “electronic banking” the electronic means for account management and payment transactions.

Nevertheless, even today, the majority of payment transactions in daily life are still performed by using cash or by issuing written transfer instructions or collection orders or similar or by using credit or check cards. In special fields, for example that of mobile radio technology electronic credit (so-called “prepaid cards”) have acquired significance, but there are significant obstacles to the wide introduction of this means of payment. However, said methods also have significant advantages over cashless “postpaid” methods, in particular the anonymity of the user as far as the trader is concerned, the absence of any formal credit rating (which makes the method particularly attractive to young people), the ease of controlling spending and protection against cancellations for the trader.

Overall, it should be established that at the current status of development, there is an extremely confusing plurality of possibilities for paying for products or services the use of which in everyday life requires considerable alertness and familiarity with a wide variety of media or input modes. This is inconvenient and also associated with numerous security risks (loss of data or credit carriers, the forgetting of account data or authentication codes, etc.).

In addition to the Internet, telecommunications, in particular mobile telecommunications, nowadays represent an area of rapid technical and economic development and a substantial source of economic growth and new social developments. For the majority of people in industrial countries, mobile telephones are increasingly becoming a universal communication and information tool and are increasingly used for accessing products and services. This development is again hindered by unsatisfactory possibilities for the secure and simultaneously simple payment for information, products and services ordered using the mobile telephone.

Although there are solutions which enable the user of a mobile telephone, with or without a prepaid card, to authorize payments which are then processed in a conventional way by debit transfer or credit card debiting, these methods, like the methods for the processing of payments which have now become established on the Internet, require the purchaser to be creditworthy and to be authorized to use a credit card or a giro account with a credit facility. In addition, these methods entail intrinsic time lags which have a detrimental impact on the transparency and reliability of the whole process.

The object of the invention is, therefore, to identify a method for the simplified processing of payment transactions using a linked telecommunication and data network.

This object is achieved with regard to its method aspect by means of a method with the features of claim 1 and with regard to its device aspect by an arrangement with the features of claim 11.

The invention involves the substantial idea of identifying an extensively universal payment method based on an electronic credit (prepaid account or card) which may used for processing a payment in the so-called B2C (business-to-consumer) area and also in the C2C (consumer-to-consumer) area and facilitates purchasing in real and real shops, payment in gastronomic or cultural establishments or at automatic product dispensers etc. and the “remittance” of sums of money in the private area. It also involves the idea of using the possibilities of a linked telecommunication and data network and, to be precise, in particular the possibility of processing in real time using a code assigned to the money receiver generally or to the individual transaction.

Here, electronic credit should be understood to mean the stored content of a credit store which may be handled by means of a telecommunication or data network for making payments, in principle regardless of whether the store actually has a prepaid credit or a credit amount is only transferred at a later time. In the following description and the claims, the owner of the prepaid credit who wishes to transfer a sum of money and appears in a (real or virtual) shop as a purchaser and visits a gastronomic establishment as a guest is generally referred to as the “money sender”. The recipient of the sum of money to be transferred, who in daily life is usually the owner or operator of a shop or a gastronomical or cultural establishment or similar will be generally referred to as the “money receiver”. The money receiver and money sender may also be applications, the money receiver, for example, an application in an automatic product dispenser (vending machine).

The center pieces of the suggested arrangement and the suggested method are a first and a second server of service operators (or also one single service operator) on which an account of the money receiver accessible for electronic money transfers and an electronic credit or an account of the money sender accessible for an electronic transfer are managed. In addition to the associated account numbers (account codes), stored on these servers—which in extreme cases could also be implemented in the form of a single server of a individual service operator—are the identifications for the money receiver and money sender necessary for addressing the information to be exchanged in connection with the money transfer; in the following these identifications will be referred to generally as the first or second identification code.

In the simplest cases, this may entail a terminal call number for a telecommunication terminal used by the money receiver or money sender. However, —when different servers are working together, as is specifically required by various operators—this identification code may comprise a server identification and, in the case of international money transfers, also a country identification (country prefix in a telecommunication network). This is a permanent “static” identification code.

In another variant of the inventive idea, identification codes are handled “dynamically” in that a unique transaction number (TAN) is assigned for each money transfer within the framework of a service and serves as the address during the necessary exchange of information. A transaction number of this kind will be requested by the money receiver before a money transfer to be performed or at its start from the first server of its service operator and generated by said server taking into account the requirement for uniqueness, by means, for example, of a random generator.

The sum of money to be transferred is entered by the money sender or receiver at their respective terminals or a till or other input device linked thereto. This may also take place in the second phase of a sequence in which first the identification code is exchanged and checked and then the money sender is prompted by means of an announcement or a menu on the part of the responsible server to enter the sum of money. On this prompt, the sender makes the relevant entry.

The use of this application in the commercial field (“B2B” or “B2C”) preferably takes place within the framework of a subscription by the money receiver. Here, in a normal case, the money receiver gives details of a bank account to which, within the framework of the prepaid shopping application, money transferred to its electronic credit store is finally transferred. In addition, it is also possible to specify the currency of the transaction. The money sender does not need to subscribe to the money transfer transaction. However, for security reasons, preferably the authorization of the money transfer is provided using predefined authentication means; more details of this are given below.

The preferred subscription to the service on the part of the money receiver is also not a mandatory requirement. However, without a formal subscription, no bank affiliation can be entered so that the money transferred to the electronic credit store (“prepaid account”) cannot be transferred any further. In this embodiment, the process is particularly suitable for a money transfer between private people (“C2C”).

After the establishment of the link or links from the terminals to the first or second server, the necessary inputs and outputs may be performed, on the one hand, by means of a voice connection with voice input or DTMF input and voice output or, on the other, by means of the exchange of text messages (in particularly SMS or email) or by means of a combination of these or by USSD.

With the above-mentioned subscription process, a data record relating to the money receiver is filed in a transaction database at the first server. The money receiver's account must be suitable for managing electronic credit; this may in particular—as in the case of the money sender—be a prepaid account. The money receiver may use several telephone numbers and also several target accounts for the money transfer, whereby in this case obviously all telephone numbers and account numbers to be used are to be filed in the database.(In the following, the term “account code” should be understood to mean the entirety of an account number or an account code and any required server address of an external server on which the account is managed). In addition to the data mentioned, the money receiver data record stored in the transaction base expediently also contains a name or company name.

A substantial security component is represented by the already mentioned authentication data record within the money sender data record. In addition to the MSISDN, this comprises in particular an authentication code (PIN or similar) and/or biometric data for the money sender (e.g. papillary line or pattern of the retina) which are used for the ad hoc authorization of money transfers. This code or this data is input at the terminal of the money sender or a terminal assigned to it, transmitted to the first server and there compared with the corresponding filed data. As a result of the comparison, the transaction is released or blocked. Applied on the part of the money receiver in the commercial area are authentication mechanisms which are known per se and practiced in business dealings.

In a preferred performance of the method, the authorization steps mentioned are not performed for small sums, but only for sums of money exceeding a predefined threshold value. This threshold value may advantageously be set or changed by the service operator or the actual money sender.

The suggested solution comprises the function blocks (1) start of the money transfer transaction and checking procedures (2), debiting from the money sender and (3) crediting to the money receiver. These function blocks may run on one and the same server or different servers, for which the terms “first server” and “second server” are used. The server or server(s) may exist centrally at the location of a service operator or in several hardware implementations there or even at several service operators. As already explained above, the application preferably has access to a database which (depending upon the specific network and application concept) may also exist centrally at a server, be distributed at the first or second server or also exist in several copies in different places.

The suggested method offers as a real-time method better transparency and reliability than known methods for the processing of payments. It also has the substantial advantage that electronic money in a prepaid account may be used not only to pay for a narrowly specified service (especially telephone conversations), but may be used in diverse ways for payment for products, services, information etc. in real and virtual selling units of all types. Due to the advance payment of the credit, users have strict cost control over substantial parts of their living costs and the possibility of the unintentional contraction of debt is in principle excluded. This makes this method particularly advantageous for minors (or even for elderly people who are no longer in full possession of their mental abilities) for whom up to now there has not been any comparable application.

Other substantial advantages of the suggested solution or special embodiments thereof are the following:

The method functions regardless of whether the money receiver has formally subscribed.

The money sender and money receiver may be registered with different operators and it is not even necessary for the money sender's service operator to transmit the money sender's identification code (the MSISDN) to another service operator.

The money sender remains anonymous to the actual money receiver and to the money receiver's operator since no data specific to the person is transmitted.

This means that the money receiver does not need to register with several service operators if it has contact with money senders registered with different service operators.

Only a short time is required for the entire transaction, i.e. it almost runs in real time.

The money sender may permanently process its transactions via the service operators known to and trusted by it and in doing so obtain a high degree of security for its money transfers.

The infrastructure of the available mobile radio networks and service operators may be used sensibly at the consumer end.

The method is to a large extent resistant to improper blockading attempts from outside.

Advantages and expediencies of the invention may also be derived from the dependent claims and the following description of a preferred embodiment with reference to the drawing. The drawing is as follows:

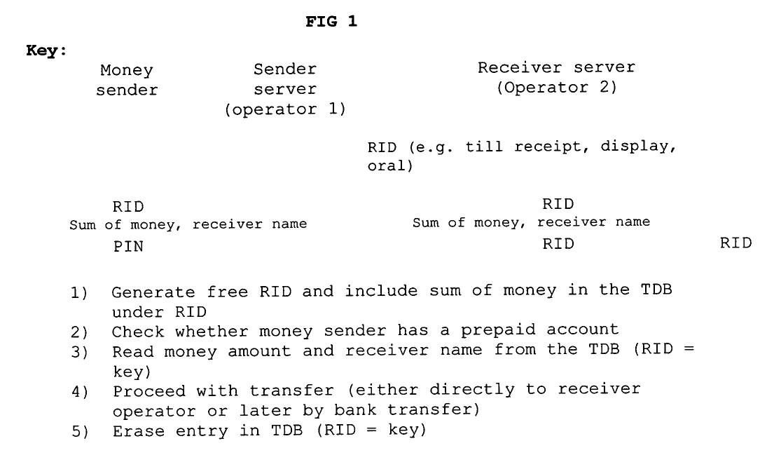

FIG. 1 a greatly simplified functional block diagram of a first form of an embodiment of the arrangement in accordance with the invention.

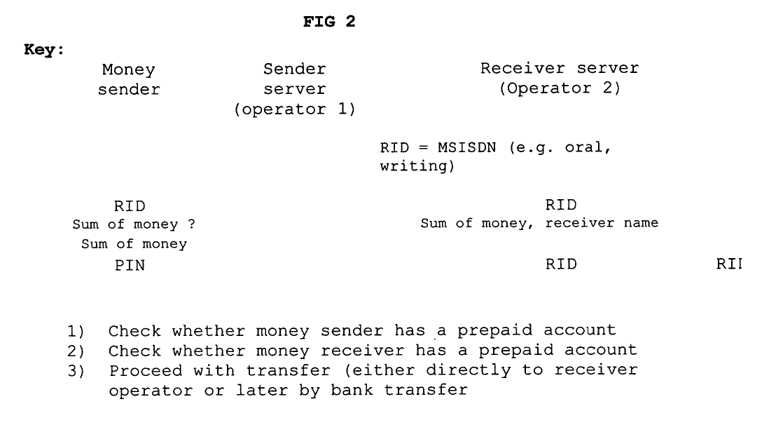

FIG. 2 a greatly simplified functional block diagram of a second form of an embodiment.

FIG. 1 shows a schematic diagram of substantial steps of the suggested application in a first form of an embodiment (consumer-to-vendor) and FIG. 2. a schematic diagram of substantial steps of the suggested application in a second form of an embodiment.

Due to their inscription, the diagrams are substantially self-explanatory so that no detailed description of the diagrams is given in the following.

Reference is made to the fact that it is assumed in FIGS. 1 and 2 that the application and the prepaid accounts handled by this are managed on different servers. It has already been mentioned above that the application may also run on different servers of a single service operator or even on one and the same server of a service operator on which both a prepaid credit of the money sender and an electronically accessible account of the money receiver may be managed.

First a case will be considered with reference to FIG. 1 in which a user (consumer) wishes to pay for a product or service in a shop, at a automatic dispenser or even on the Internet (from a “vendor”) by money transfer from its prepaid credit.

To receive the money, the money receiver (vendor) requires a valid identification code for the planned money transfer which may in particular take the form of a sequence of numbers and in this case is referred to as the transaction number (TAN). The money receiver obtains this TAN via a link to its service operator which may be fixed or only established when required. The TAN may be generated immediately and transmitted to the money receiver before the sale of the product or service and the associated money transfer procedure or even in advance i.e. before the sum of money to be transferred is known.

The assignment of a TAN in advance may be sensible to accelerate the course of a transaction. With this variant, the sum of money to be transferred for the actual payment transaction with the TAN as an address (code) must be stored in a transaction database. In the alternative embodiment, the sum of money is transmitted to the service operator in conjunction with the request for the TAN and entered immediately in the transaction database by the first server together with the currently generated TAN. It goes without saying that together with the transaction number forming the address and the sum of money, an identification for the money receiver is entered in the database, in particular its terminal call number or even immediately an account code for its prepaid account to be used for the money transfer transaction.

For trade in real shops, an embodiment is required in which the till device is directly coupled to a terminal for connection to the first server so that in the case of a prepaid payment transaction, a connection to the service operator is automatically established and the sum of money to be transferred is automatically transmitted. In virtual shops (Internet shops), the automatic transmission of the sum of money is the normal case.

The transaction number is notified to the money sender by the money receiver; this takes place in a real shop in particular by means of a printout on the till receipt, optical display on the till device or an additional device or, in some circumstances, even orally and in the case of Internet shopping by a display on the screen or on the money sender's mobile telephone—depending upon the specific embodiment of the application, however, the use of separate technical transfer channels (Bluetooth, Interoute, etc.) is also feasible.

When the money sender has recognized the TAN, it establishes a connection to its service operator's server (here, generally referred to as the “second server”). This call number cannot in principle be changed and represents a terminal call number or a special number (IN service number). This is expediently prestored in the money store's terminal—either in the telephone directory or directly in the main menu with an assignment to a selection button. A signaling connection to USSD may also be used for the transmission.

Here, it should be noted that the input of the “pure” TAN is only sufficient if the money receiver is registered with the same service operator as the money sender. Otherwise, an operator ID (NDC) has to be entered and, in the event of an international money transfer, also the country prefix or identification for the foreign network in which the server for the foreign service operator may be accessed. It goes without saying that the input of an insofar complete (maximum) identification code makes the handling of all these cases possible, albeit for the cost of a longer input process.

Following the transmission of the data with which the money transfer transaction is started, first, a checking process takes place with regard to whether the identification code is valid and the sum in the money sender's prepaid account is sufficient for the planned transfer process. If both are the case, the money sender is prompted to authorize the debiting of the sum of money to be transferred by entering its PIN.

Within the framework of this checking process, firstly, the second server establishes a connection to the first server. If—as in FIGS. 1 and 2—the two servers are running on different servers, this is performed by means of the operator ID and, where appropriate, also the country prefix or a suitable network identification. In the first server, it is identified after the establishment of the connection that the data record transmitted is a TAN and using the TAN as a key, the relevant transaction data (sum of money, currency, identification and possibly also the name of the money receiver) read from the transaction database and transmitted to the second server. If no entry is found in the transaction database, the TAN is invalid and the transfer process is terminated.

At the money sender's second server, a prompt is issued to check whether the electronic credit in the money sender's prepaid account is sufficient for the planned money transfer. If this is not the case, the transfer will be terminated with a corresponding notification signal to the terminal of the money receiver and/or money sender. If the sum of money to be transferred is covered, it will be reserved in the money sender's prepaid account.

Finally, the mentioned authorization is performed by the money sender. For this, the second server transmits the relevant transaction data (sum of money, currency and name or identification of the receiver) as a text message for optical display on its terminal or also by means of the synthesis and transmission of a voice message to the money sender. For the authentication and authorization of the transfer process, said money sender will enter a PIN, for example. The PIN entered will be compared with the PIN filed in the money sender data record. If it is valid, the debiting process will be initiated. If it is invalid, the transaction will be terminated at this point and once again a corresponding notification signal transmitted.

The sum of money to be transferred is debited from the money sender's prepaid account. This process is time-critical and performed in real time. If the money sender's prepaid account is located at the same operator as that of the money receiver, the credit may be credited to the money receiver immediately (in real time). If the account is located on an alien operator, the crediting prompt should be issued to the account management there and the crediting performed under its regime. For this, the participating service operators must have adopted corresponding rules. The transfer of the sum of money to the other service operator is performed, for example, via the conventional process of a bank transfer.

In each case, it make sense to establish a log of the debiting process and to inform the money receiver and/or money sender of the performance of the debiting via the till system or a call or by SMS or similar. The confirmation of the transaction is hereby transmitted by the second server to the first server whereby the TAN is again used as a key for the identification of the transaction. The first server generates a payment confirmation and transmits it to the money receiver's terminal. This message triggers the delivery of the product to the consumer by the vendor or a vending machine (for example, an automatic ticket or drinks dispenser). Finally, when the product or service has been output, the entry of the process in the transaction database is erased and the TAN released for a new application.

The sum of money to be transferred is credited to the money receiver's account which may be a prepaid account, a real-time account or a normal giro bank account. This process is not time-critical but must take place with maximum reliability. Once again, a differentiation should be made between the variants for debiting mentioned above, depending upon whether the account is kept on an alien server or not. A log record is also compiled for the crediting process.

The case of a money transfer between private people, which is here also referred to as a consumer-to-consumer application, is to a large extent similar to that of the above-described commercial application, but some steps are omitted or there are certain modifications.

In particular, normally transaction numbers relative to the individual transfer process are not required and issued, but the necessary checking processes, including the associated memory accesses are performed by means of a identification code permanently assigned to the money receiver, in particular its terminal call number. Correspondingly, neither is there a transaction database in the specific sense with data records which may be addressed and read by means of the TAN. In the corresponding checking process, the service operator merely checks whether the money receiver's identification code (money receiver number) is a valid MSISDN and the money receiver has a prepaid account.

Since in this embodiment, the second server (of the money sender) does not receive any transaction data from the first server, the transmission of the relevant sum of money cannot take place in this manner either. Rather, the second server generates and transmits a prompt to the money sender to enter the sum of money to be transferred.

The transfer of a transaction confirmation from the second server to the first server is optional in this case and not usually time-critical since in normal cases the delivery of a product or service is dependent upon receiving the confirmation of the transaction. However, it is quite possible to create a debiting and/or crediting confirmation and transmit it to the money receiver via SMS or email, for example. In this context, the individual identification of individual money transfer transactions (to differentiate them from other transactions performed close to real-time) may be expedient; however, in the consumer-to-consumer area, an identification of the individual transfer process will normally emanate from the money receiver and only be transferred by the service operator as additional information.

The embodiment of the invention is not restricted to the mentioned examples, variants and aspects but, within the framework of the claims, is also possible in a plurality of modifications lying within the framework of expert action. In particular, the procedural steps described above are also possible in a different sequence).

1. Method for the transfer of an electronic sum of money from a credit store which in particular has a prepaid credit to an account or credit store of a money receiver by means of a telecommunication and data network with the following steps
issue of a first identification code for the money receiver or a transfer operation to the money receiver,
storage of a money receiver data record comprising at least the first identification code and an account code for the money receiver's account or credit store in a transaction database and/or a first account management database at a first server of a service operator
storage of a money sender data record comprising at least a second identification code, in particular a call number for a terminal and an account code for the money sender's credit store in a second account management database at a second server of a service operator,
transmission of the first identification code from the money receiver to the money sender, in particular outside the telecommunication and data network,
establishment of a connection between the money sender's terminal and the second server using a server call number or a special number and transmission of the first identification code to the second server,
establishment of a data connection between the second and first servers of the service operators of the money sender and money receiver or a common service operator whereby a section of the first identification code is used to dial or select the first server and transmission of the first identification code to the first server,
checking of the first identification code and the existence of an account or credit store of the money receiver and, if the result of the check is positive, assignment of the account code to the first identification code and transmission of the result of the check to the second server
entry of the sum of money to be transferred at the money receiver's or money sender's terminal and transmission to the second server,
checking that the sum of money is covered in the money sender's credit store and reservation of the sum of money in the event of coverage or termination with signaling in the event of deficient cover,
issue of a request to the money sender for the authorization of the transfer,
transmission of the authorization entry from the money sender's terminal to the second server and checking at said sender,
debiting the sum of money from the money sender's credit store in real time and documentation of this in the event of a positive result to the check or termination in the event of a negative result,
crediting of the sum of money to the money receiver's account or the money receiver's credit store and documentation of this,
transmission of information on the debiting and/or crediting to the terminal of the money receiver and/or money sender.

2. Method according to claim 1, characterized by the use of a permanently valid money receiver number, in particular the call number of the money receiver's terminal, as a first identification code.

3. Method according to claim 1, characterized by the use of a specific transaction number, issued by the first server, for an individual transfer process whereby the transaction number is used to address one storage area of a transaction database established at the first server in which the data relating to the transfer process is stored.

4. Method according to any one of the preceding claims, characterized in that the sum of money to be transferred by the money sender is entered into its terminal together with the first identification code, transmitted to the second server and stored temporarily there until coverage has been checked.

5. Method according to any one of claims 1 to 3, characterized in that the second server generates and transmits a request for the input of the sum of money to be transferred to the money sender and outputs it at the money sender's terminal and
in reaction to this request, the sum of money is input at the money sender's terminal.

6. Method according to any one of the preceding claims, characterized in that the money sender data record comprises an authorization data record, in particular an authentication code or biometric data for the money sender and before the debiting step the following steps are performed for the authorization of said step:
entry of the authentication code or the biometric data by the money sender at its terminal,
transmission of said code to the second server and
comparison of the transmitted data with the data in the money sender data record and output of a debit release signal in the event of conformity or a debit blocking signal in the event of non-conformity.

7. Method according to any one of the preceding claims, in particular claim 6, characterized in that the steps for authorization are performed in the event of a sum of money exceeding a prespecified threshold which may be set in particular by the service operator or the money sender.

8. Method according to any one of the preceding claims, characterized in that within the framework of the money receiver's subscription with the service operator, an account number for a regular bank affiliation is stored in the money receiver's data record.

9. Method according to any one of the preceding claims, characterized in that the money receiver's subscription with the service operator takes place with a plurality of accounts and/or identification codes, in particular call numbers, whereby in particular the number of accounts is less than that of the call numbers and whereby all corresponding account codes and the identification codes are stored in the money receiver's data record.

10. Method according to any one of the preceding claims, in particular any one of claims 2 to 9, characterized in that the money receiver number comprises a country prefix number and a server identification code for the first server.

11. Arrangement for the transfer of an electronic sum or money from a money sender's credit store, which in particular contains prepaid credit, into an account or credit store of a money receiver by means of a telecommunication and data network in real time, in particular for the performance of the method in accordance with one of the preceding claims, comprising:
a first server with at least one money receiver credit store and one money receiver data store and comparator means to compare received money receiver data, in particular for an identification code for a money receiver or a transfer process with stored money receiver data.
a second server with at least one money sender credit store and one money sender data store and means for the comparison of received money transfer data, in particular a sum of money to be transmitted with stored money sender credit data or money sender data,
wherein the first and second server are connected or connectable or integrated with each other by means of a data line in the telecommunication and data network,
a terminal of the money receiver connected to the telecommunication and data network and
a terminal of the money sender connected to the telecommunication and data network.

12. Method according to claim 11, characterized in that a first transaction database is stored on the first server in which transfer-relevant data is stored under an identification code for the money receiver or the transfer process, in particular an account code and credit status of the money receiver.

13. Arrangement according to claim 11 or 12, characterized in that the money sender data store comprises a storage area to store an authentication data record for the money sender and is assigned comparator means for the comparison of currently entered authentication data with stored authentication data and for the output of a release or blocking signal for the transfer process as a result of the comparison.

14. Arrangement according to any one of claims 11 to 13, characterized in that the first server has random generator means to generate the identification code for the unique identification of a transfer process and linking means for the assignment of the identification code to the money receiver data record.

15. Arrangement according to any one of claims 11 to 14, characterized in that the first server and/or second server has means for the documentation of a termination process and a crediting process, in particular as a log record.

16. Arrangement according to any one of claims 11 to 15, characterized in that the first server and/or second server has telecommunication means for signaling a termination of a transaction or a debiting and/or a crediting to the terminal of the money sender and/or the money receiver.

17. Arrangement according to any one of claims 11 to 16, characterized in that the telecommunication and data network comprise a mobile radio network whereby the terminal of the money sender and/or the terminal of the money receiver is embodied as a mobile radio terminal or a data processing device fitted with a mobile radio part and a mobile radio terminal is assigned to the first and/or second server.

18. Arrangement according to any one of claims 11 to 17, characterized in that the terminal of the money receiver is connected to a till device in such a way that it receives the sum of money to be transferred automatically from said till device.

19. Automatic goods dispenser for the automatic dispensing of a product or service, characterized by a data connection to an arrangement according to any one of claims 11 to 18.

20. Till device for the electronic collection of a sum of money to be paid for a product or service, characterized by a data connection to an arrangement according to any one of claims 11 to 18.
